(19) United States
(12) Patent Application Publication
(10) Pub. No.: US 2008/0228927 A1
(43) Pub. Date: Sep. 18, 2008

(54) Server directed browsing

(75) Inventor: Stephen H. Toub, Seattle, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/724,512

(22) Filed: Mar. 15, 2007

(51) Int. Cl. G06F 15/16

(52) U.S. Cl. 709/228

(57) ABSTRACT

Various technologies and techniques are disclosed for providing server directed browsing. After determining that a user needs assistance with one or more particular issues, a client browser being operated by the user and a server agree on a unique communication identifier. The client browser sends asynchronous requests to the server after the client browser loads a script library which causes the asynchronous requests to begin. One or more appropriate responses are received, such as from a responding user. The response is submitted to a command queue on the server so that the asynchronous requests from the client browser will pick up the response on a later communication. The response is one or more commands that the client browser later executes.

### BACKGROUND

Many computer systems allow one user to issue commands to another user's computer. Although these systems provide value, there are drawbacks. Most computer systems that allow one user to send instructions to another user's computer require that the first user relinquish control of their computer to the second user. This means that the first user is no longer the only user in control of their computer and the second user is free to perform any available action, including potentially damaging actions. In most instances where remote assistance is desired, such as with customer service situations, the first user does not implicitly trust the second user. The first user is left either with having to trust that the second user will not do damaging things to their computer or with foregoing the assistance.

The problem with current remote assistance systems is not just limited to the trust issue. A user wishing to participate in these systems may have to make certain adjustments to their security software, such as to a firewall or to a policy controlling whether the remote user is allowed take control of their system, if such adjustments are even permitted based on the environment. This further exposes their computer to potentially dangerous infiltrations by yet a third user who does not even have authorization to be on the computer.

### SUMMARY

Various technologies and techniques are disclosed for providing server directed browsing. A user asks for assistance with one or more particular issues, such as by telephone, online, or using another communication mechanism. A script library is sent to a client browser being operated by the user seeking the assistance. The server and the client browser agree on a unique communication identifier. In one implementation, the server sends the unique communication identifier to the client browser. In another implementation, the client browser provides the unique communication identifier to the server.

The client browser sends asynchronous requests to the server after the client browser loads the script library which causes the asynchronous requests to begin. One or more appropriate responses are received. In one implementation, the appropriate response is received from a responding user, such as a customer service representative. In another implementation, the appropriate response is received programmatically. The response is submitted to a command queue on the server so that the asynchronous requests from the client browser will pick up the response on a later communication. The response is a command that the client browser later executes.

This Summary was provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a diagrammatic view of a server directed browsing system, in one implementation.

FIG. 2 is a diagrammatic view of server directed browsing application of one implementation of the system of FIG. 1.

FIG. 3 is a high-level process flow diagram for one implementation of the system of FIG. 1.

FIG. 4 is a process flow diagram for one implementation of the system of FIG. 1 illustrating the stages involved in responding to a request from a client browser from a command workstation.

FIG. 5 is a process flow diagram for one implementation of the system of FIG. 1 illustrating the stages involved in having a responding user select the proper response to the client browser from a list of available responses.

FIG. 6 is a process flow diagram for one implementation of the system of FIG. 1 illustrating the stages involved in having a responding user selects the proper response to the client browser by entering one or more actual commands directly.

FIG. 7 is a process flow diagram for one implementation of the system of FIG. 1 that illustrates the stages involved in enabling a client browser to be directed by a server.

FIG. 8 is a process flow diagram for one implementation of the system of FIG. 1 that illustrates the stages involved in providing a customer service application using server directed browsing.

FIG. 9 is a process flow diagram for one implementation of the system of FIG. 1 that illustrates the stages involved in providing a system that provides server directed browsing programmatically.

FIG. 10 is a process flow diagram for one implementation of the system of FIG. 1 that illustrates the stages involved in providing training using server directed browsing.

FIGS. 11a, 11b, and 11c are simulated screens for one implementation of the client browser of FIG. 1 that illustrates what a client application user might see when using a server directed browsing application.

FIG. 12 is a simulated screen for one implementation of the system of FIG. 1 that illustrates what a command workstation user might see when using a server directed browsing application to select a command from an available list to send to the client browser.

FIG. 13 is a simulated screen for one implementation of the system of FIG. 1 that illustrates what a command workstation user might see when using a server directed browsing application to type in an actual command to send to the client browser.

FIG. 14 is a diagrammatic view of a computer system of one implementation.

### DETAILED DESCRIPTION

For the purposes of promoting an understanding of the principles of the invention, reference will now be made to the embodiments illustrated in the drawings and specific language will be used to describe the same. It will nevertheless be understood that no limitation of the scope is thereby intended. Any alterations and further modifications in the described embodiments, and any further applications of the principles as described herein are contemplated as would normally occur to one skilled in the art.

The system may be described in the general context as an application that provides server directed browsing, but the system also serves other purposes in addition to these. In one implementation, one or more of the techniques described herein can be implemented as features within a browser-based customer service program, or from any other type of program or service that provides online assistance and/or training over the Internet.

In one implementation, a system is provided that allows a server to direct the browsing experience on a client browser. The server can send the specific script or command to execute in response to a customer's specific question. An example of this might be to navigate the customer's browser to a particular page that contains the information or file the customer is looking for. This system allows the user to turn control of the browser over to an unknown third party, while still preserving the security settings that are already in place in the browser environment based on the zone in which the browser is operating. In other implementations, the server directed browsing techniques can be used to provide training to users of how a web site or other browser application operates.

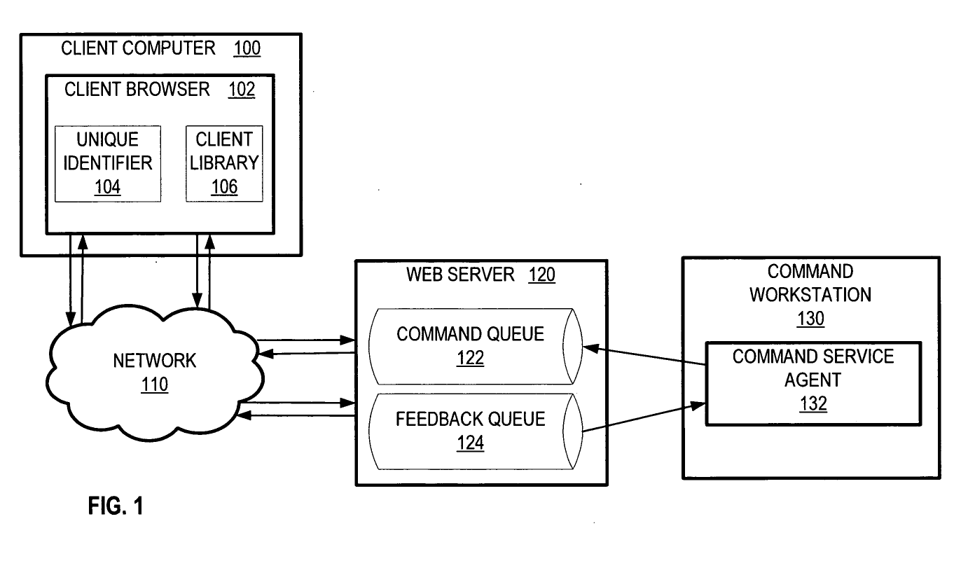

As shown in FIG. 1, an exemplary computer system to use for implementing one or more parts of the system includes some number of client computers 100, a network 110, some number of web servers 120, and some number of command workstations 130. In one implementation, client computer 100 contains client browser 102. A unique communication identifier 104 is established with web server 120. Unique communication identifier 102 is an identifier whose purpose is to uniquely identify the client application to other components of the system. In one implementation, client library 106 is sent to client computer 100 from web server 120. In another implementation, the library could be distributed through one or more other means. Client library 106 is a collection of computer instructions that enable a client application to function within the server directed browsing system. Network 110 is used to provide communication between client computer 100 and web server 120. Network 110 can be implemented as a local area network, wide area network, over the Internet, using a wired or wireless connection, and/or in other such variations as would occur to one of ordinary skill in the computer software art.

As noted previously, web server 120 communicates with client application 102. Web server 120 also contains, in one implementation, command queue 122 and feedback queue 124. A command queue is a data store where commands are stored until a client application, such as client application 102, requests the commands. Commands are computer instructions (executable commands and/or scripts) operable to make an application perform a desired action. A command queue may be implemented in memory, in a database management system, in files on a hard disk, and/or in other such variations as would occur to one of ordinary skill in the computer software art. A feedback queue 124 is where information sent by a client application, such as client application 102, is stored for use later by a command service agent, such as command service agent 132. A feedback queue may be implemented in memory, in a database management system, in files on a hard disk, and/or in other such variations as would occur to one of ordinary skill in the computer software art. In another implementation, feedback queue is not used at all.

Command workstation 130 is a computer that contains command service agent 132. In one implementation, command service agent 132 is a computer application that sends commands to command queue 122 which, ultimately, will be retrieved and executed by client application 102. In addition, command service agent 132 may also receive information from feedback queue 124.

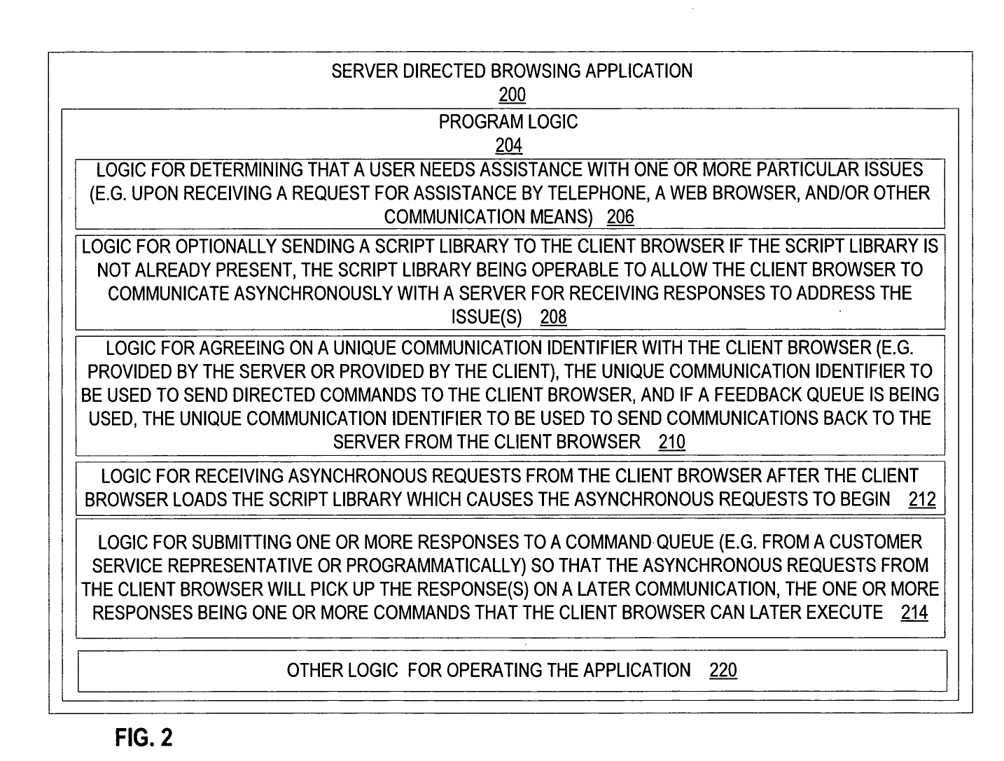

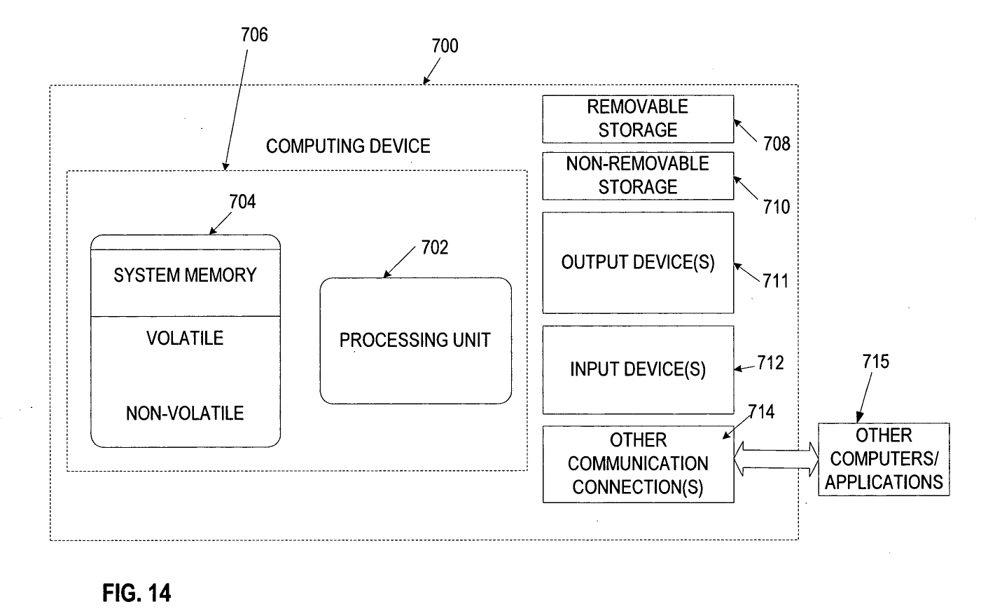

Turning now to FIG. 2 with reference to FIG. 1, server directed browsing application 200 operating on computing device 700 (of FIG. 14) is illustrated. In one implementation, server directed browsing application 200 is one of the application programs that reside on computing device 700 (of FIG. 14). However, it will be understood that server directed browsing application 200 can alternatively or additionally be embodied as computer-executable instructions on one or more computers and/or in different variations than described herein. Alternatively or additionally, one or more parts of server directed browsing application 200 can be part of system memory 704 (of FIG. 14), on other computers and/or applications 715 (of FIG. 14), or other such variations as would occur to one skilled in the computer software art.

Server directed browsing application 200 includes program logic 204, which is responsible for carrying out some or all of the techniques described herein. Program logic 204 includes logic for determining that a user needs assistance with one or more particular issues (e.g. upon receiving a request for assistance by telephone, a web browser, and/or other communication means) 206; logic for optionally sending a script library to the client browser, the script library being operable to allow the client browser to communicate asynchronously with a server for receiving responses to address the issue(s) 208; logic for agreeing on a unique communication identifier with the client browser (e.g. provided by the server or provided by the client), the unique communication identifier to be used to send directed commands to the client browser, and if a feedback queue is being used, the unique communication identifier to be used to send communications back to the server from the client browser 210; logic for receiving asynchronous requests from the client browser after the client browser loads the script library which causes the asynchronous requests to begin 212; logic for submitting one or more responses to a command queue (e.g. from a customer service representative or programmatically) so that the asynchronous requests from the client browser will pick up the one or more responses on a later communication, the one or more responses being one or more commands that the client browser can later execute 214; and other logic for operating the application 220. In one implementation, program logic 204 is operable to be called programmatically from another program, such as using a single call to a procedure in program logic 204.

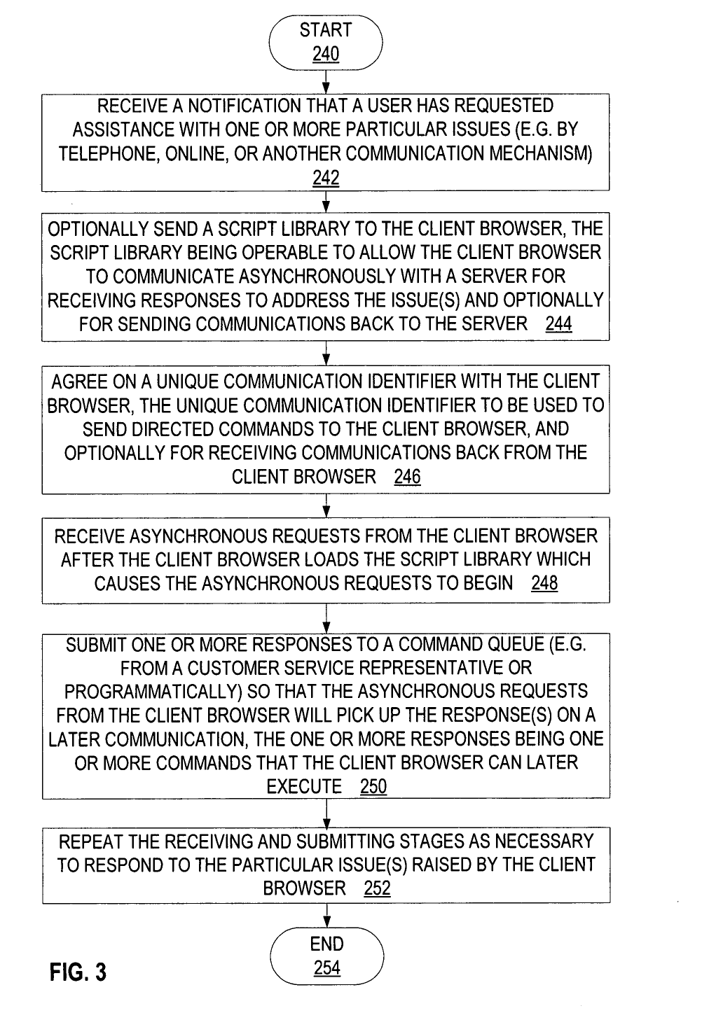

Turning now to FIGS. 3-10 with continued reference to FIG. 1, the stages for implementing one or more implementations of server directed browsing application 200 are described in further detail. FIG. 3 is a high level process flow diagram for server directed browsing application 200. In one form, the process of FIG. 3 is at least partially implemented in the operating logic of computing device 700 (of FIG. 14). The process begins at start point 240 with receiving a notification that a requesting user has asked for assistance with one or more particular issues (stage 242). In one implementation, the request is received out-of-band, such as by telephone from the user asking for assistance. In another implementation, the request is received using a computer, such as an online customer assistance option. Any type of communication means could be used to allow a user to notify a third party that assistance is requested with a particular one or more issues (e.g. on a web site, etc.). A script library is optionally sent to a client browser being operated by the requesting user, the script library being operable to allow the client browser to communicate asynchronously with a server for receiving responses to address the issue(s) and optionally for sending communications back to the server (stage 244). In one implementation, the script library is only sent if it does not already exist on the computer where the client browser is located. The script library could already be present from a prior communication, and/or it could have been installed by some other means.

A unique communication identifier is agreed upon with the client browser, the unique communication identifier to be used to send directed commands to the client browser (such as in a command queue) and optionally for receiving communications from the client browser (such as in a feedback queue) (stage 246). In one implementation, the unique identifier is created by the application on the server and sent to the client browser along with the script library. Asynchronous requests are received from the client browser after the client browser loads the script library which causes the asynchronous requests to begin (stage 248). One or more responses are submitted to a command queue (e.g. from a customer service representative or programmatically) so that the asynchronous requests from the client browser will pick up the one or more responses on a later communication (stage 250). The one or more responses are one or more commands that the client browser can later execute (stage 250). The receiving and submitting stages are repeated as necessary to respond to the particular issue(s) raised by the client browser (stage 252). The process ends at end point 254.

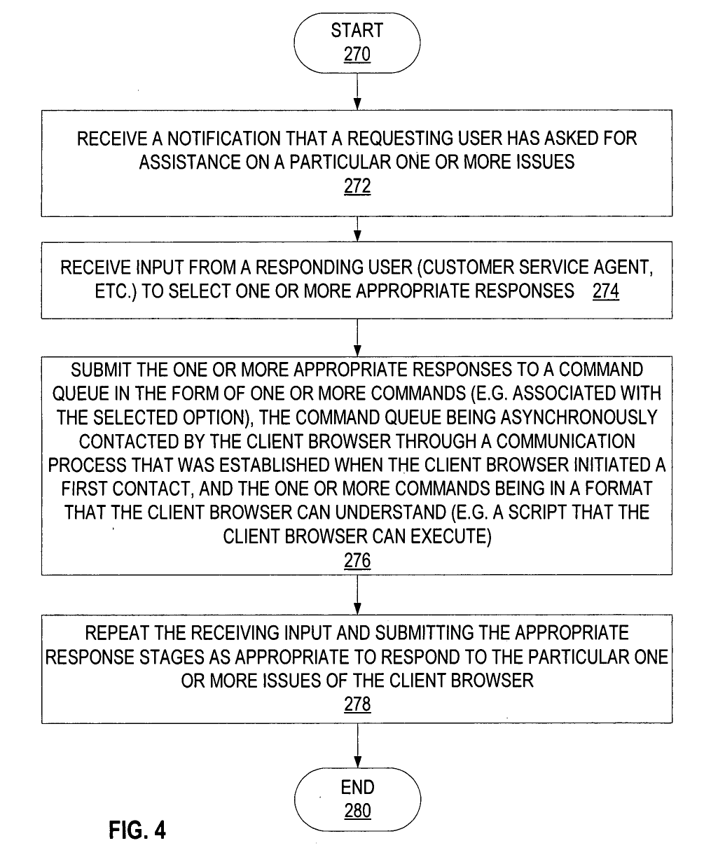

FIG. 4 illustrates one implementation of the stages involved in responding to a request from a client browser from a command workstation. In one form, the process of FIG. 4 is at least partially implemented in the operating logic of computing device 700 (of FIG. 14). The process begins at start point 270 with receiving a notification that a requesting user has asked for assistance on one or more particular issues (stage 272). Input is received from a responding user (customer service agent, etc.) to select one or more appropriate responses (stage 274). The one or more appropriates response are submitted to a command queue in the form of one or more commands (e.g. associated with the selected option) (stage 276). The command queue is asynchronously contacted by the client browser through a communication process that was established when the client browser initiated a first contact, and the one or more commands are in a format that the client browser can understand (e.g. a script that the client browser can execute) (stage 276). The receiving input and submitting the appropriate response stages are repeated as appropriate to respond to the particular one or more issues of the client browser (stage 278). The process ends at end point 280.

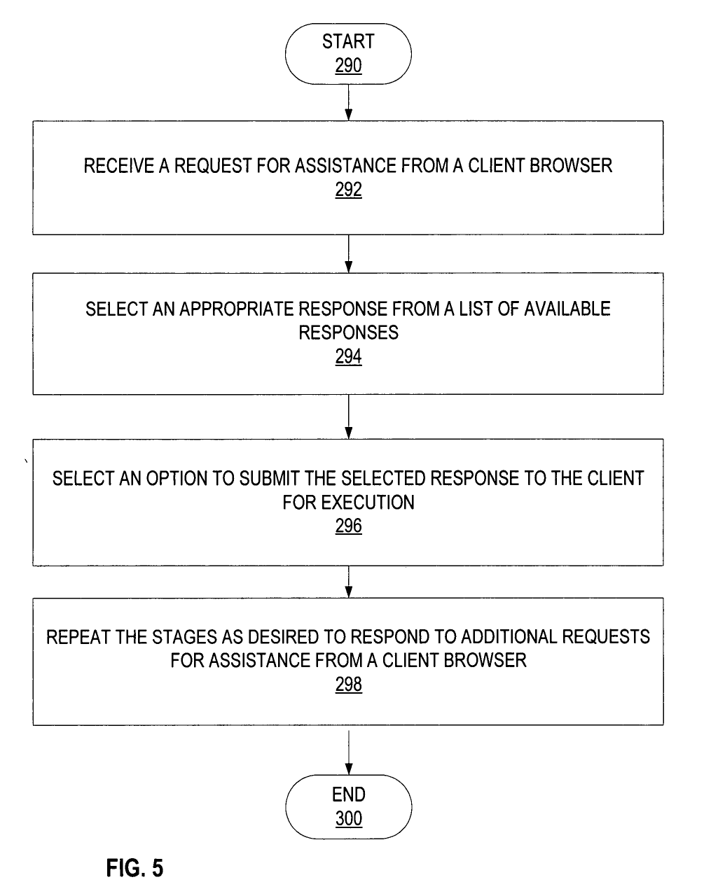

FIG. 5 illustrates one implementation of the stages involved in having a responding user, such as a customer service agent, select the proper response to the client browser from a list of available responses. In one form, the process of FIG. 5 is at least partially implemented in the operating logic of computing device 700 (of FIG. 14). The process begins at start point 290 with receiving a request for assistance from a client browser 292. An appropriate response is selected from a list of available responses (stage 294). An option to submit the selected response to the client for execution is selected (stage 296). The stages are repeated as desired to respond to additional requests for assistance from a client browser (stage 298). The process ends at end point 300.

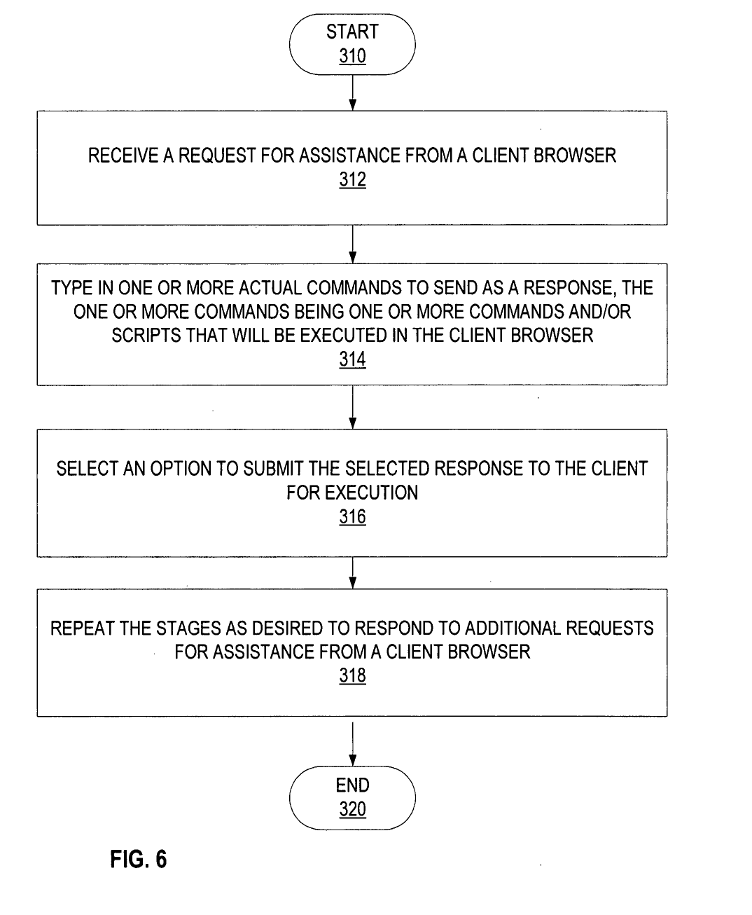

FIG. 6 illustrates one implementation of the stages involved in having a responding user, such as a customer service agent, select the proper response to the client browser by entering one or more actual commands directly. In one form, the process of FIG. 6 is at least partially implemented in the operating logic of computing device 700 (of FIG. 14). The process begins at start point 310 with receiving a request for assistance from a client browser (stage 312). The user types one or more actual commands in to send as a response, the one or more commands being one or more commands and/or scripts that will be executed in the client browser (stage 314). In one implementation, the entered one or more commands can be saved so that they can later be accessible from a list of available commands. The user selects an option to submit the selected response to the client for execution (stage 316). The stages are repeated as desired to respond to additional requests for assistance from a client browser (stage 318). The process ends at end point 320.

In one implementation, the responding user (e.g. customer service agent, trainer, etc.) can actually perform the actions in his local browser, which are then translated into commands which are entered into the command queue for pickup by the client browser. In this implementation, rather than directly entering commands and/or choosing the responses from a list, the responding user is simply performing the actions. These commands are then sent to the client browser, which results in those same actions happening on the client.

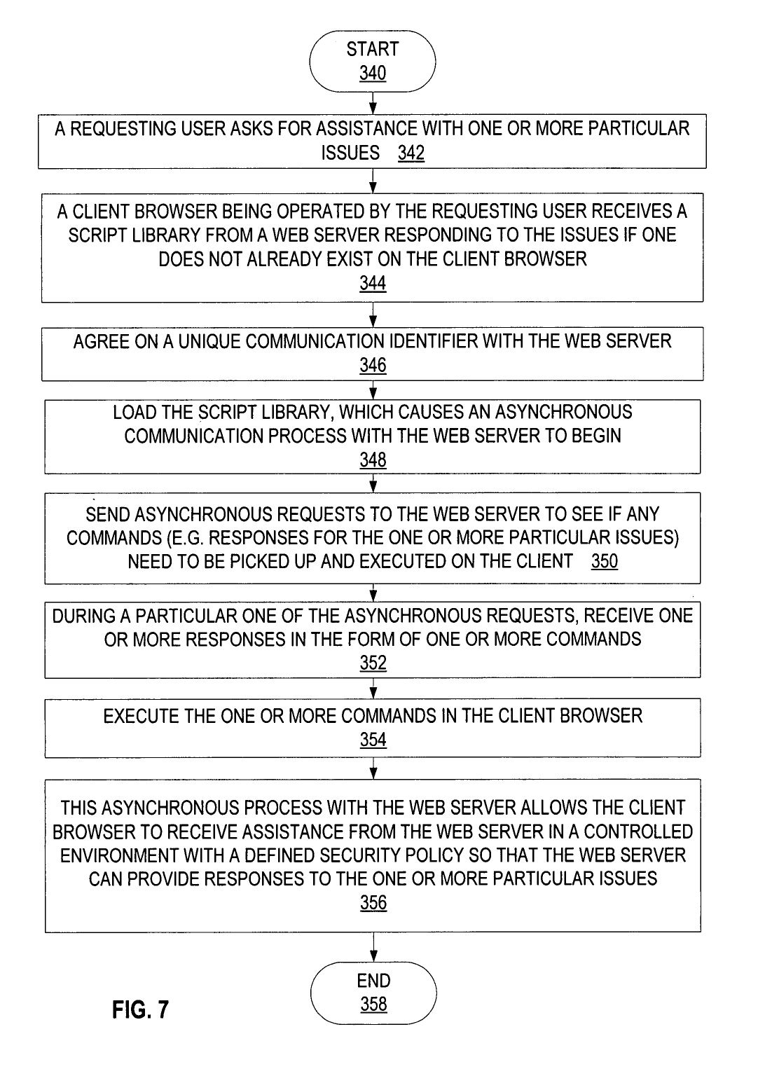

FIG. 7 illustrates one implementation of the stages involved in enabling a client browser to be directed by a server. In one form, the process of FIG. 7 is at least partially implemented in the operating logic of computing device 700 (of FIG. 14). The process begins at start point 340 with a requesting user asking for assistance with one or more particular issues (stage 342), such as by telephone, online, and/or other communication mechanisms. A script library is received from the web server (stage 344) if is not already present on the computer where client browser is located. A unique communication identifier is agreed upon with the web server (stage 346). The script library is loaded, which causes an asynchronous communication process with the web server to begin (stage 348). Asynchronous requests are sent to the web server to see if any commands (e.g. responses for the one or more particular issues) need to be picked up and executed on the client (stage 350). During a particular one of the asynchronous requests, one or more responses are received in the form of one or more commands (stage 352). The one or more commands are executed in the client browser (stage 354). This asynchronous process with the web server allows the client browser to receive assistance from the web server in a controlled environment with a defined security policy so that the web server can provide responses to the one or more particular issues (stage 356). The process ends at end point 358.

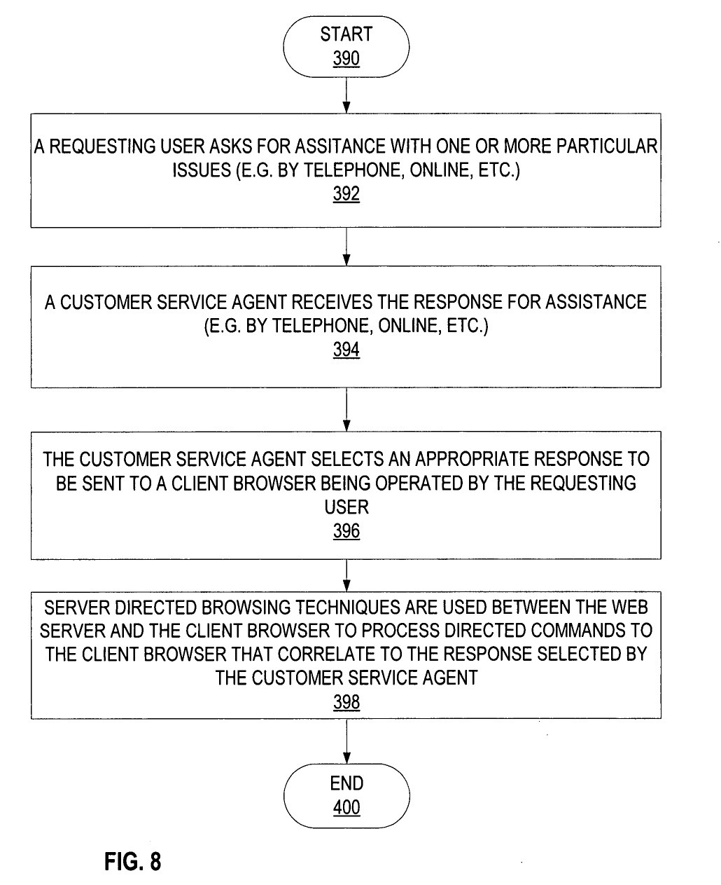

FIG. 8 illustrates one implementation of the stages involved in providing a customer service application using server directed browsing. In one form, the process of FIG. 8 is at least partially implemented in the operating logic of computing device 700 (of FIG. 14). The process begins at start point 390 with a user asking for assistance with one or more particular issues (e.g. by telephone, online, etc.) (stage 392). A customer service agent receives the response for assistance (e.g. by telephone, online, etc.) (stage 394). The customer service agent selects an appropriate response that is to be sent to a client browser being operated by the requesting user (stage 396). Server directed browsing techniques are used between the web server and the client browser to process directed commands to the client browser that correlate to the response selected by the customer service agent (stage 398). The process ends at end point 400.

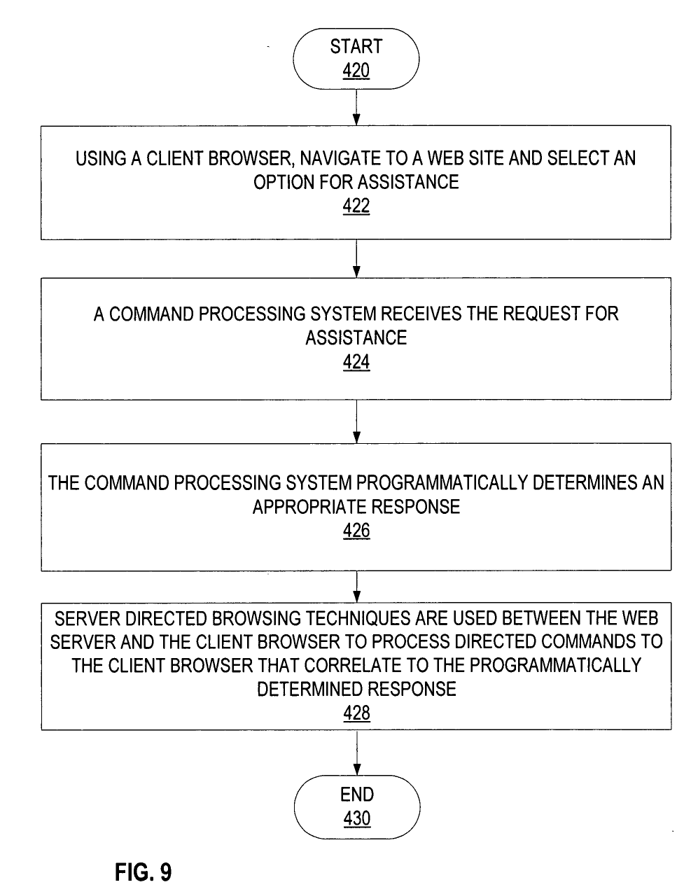

FIG. 9 illustrates one implementation of the stages involved in providing a system that provides server directed browsing programmatically. In one form, the process of FIG. 9 is at least partially implemented in the operating logic of computing device 700 (of FIG. 14). The process begins at start point 420 with using a client browser to navigate to a web site and select an option for assistance (stage 422). A command processing system receives the request for assistance (stage 424). The command processing system programmatically determines an appropriate response (stage 426). Server directed browsing techniques are used between the web server and the client browser to process directed commands to the client browser that correlate to the programmatically determined response (stage 428). The process ends at end point 430.

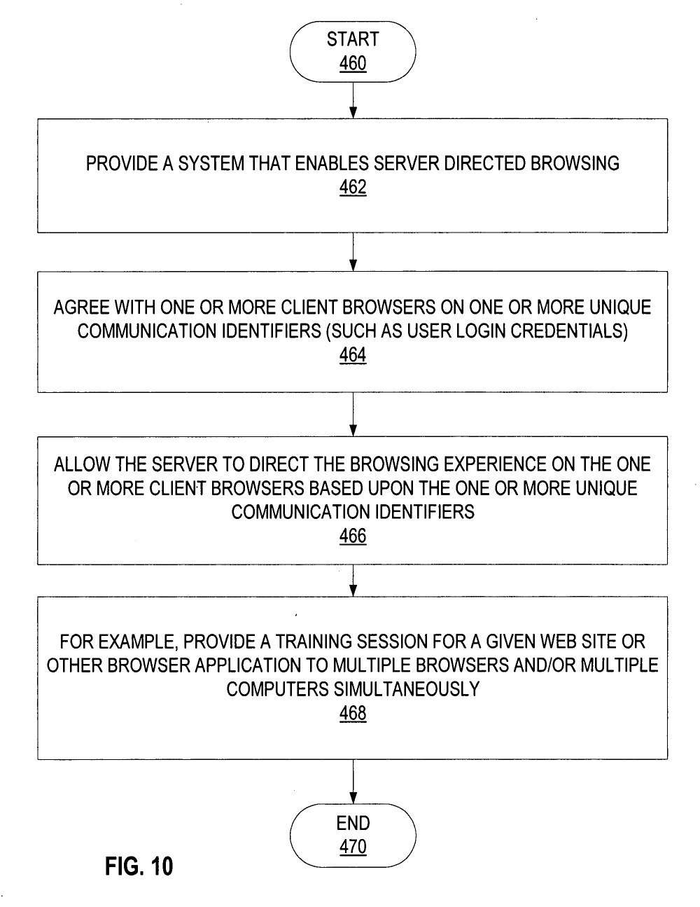

FIG. 10 illustrates one implementation of the stages involved in providing training using server directed browsing. In one form, the process of FIG. 10 is at least partially implemented in the operating logic of computing device 700 (of FIG. 14). The process begins at start point 460 with providing a system that enables server directed browsing (stage 462). The server agrees with one or more client browsers on one or more unique communication identifiers, (such as user login credentials) (stage 464). The server directs the browsing experience on the one or more client browsers based upon the one or more unique communication identifiers (stage 466). In one implementation, a single command can be issued one time and then picked up by multiple computers because they all have the same unique communication identifier. In another implementation, the same command can be issued multiple times, one for each of the unique communication identifiers. For example, a training session can be provided for a given web site or other browser application to multiple browsers and/or multiple computers simultaneously (stage 468). The process ends at end point 470.

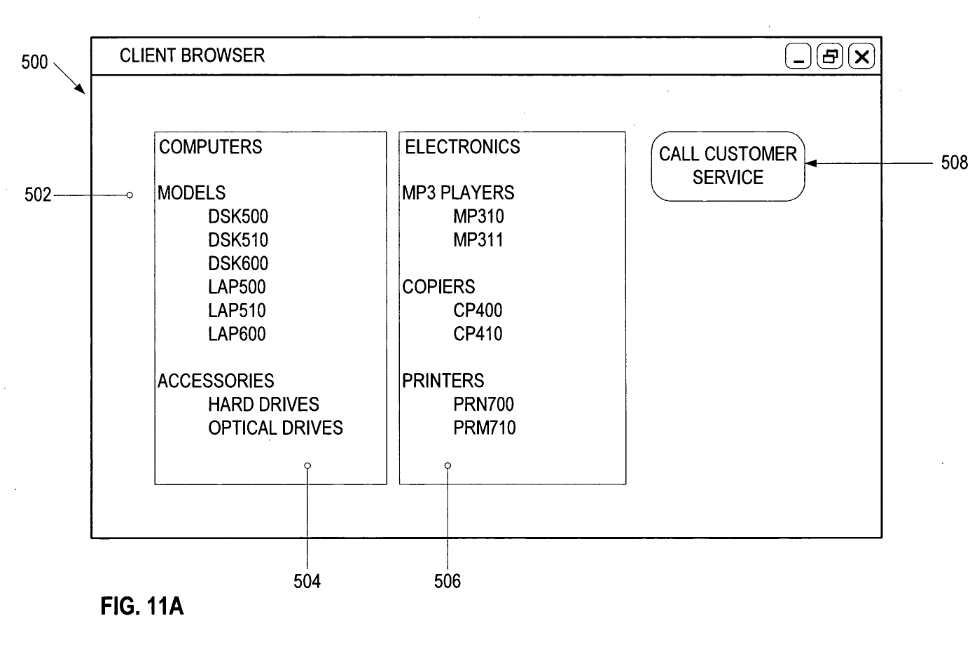

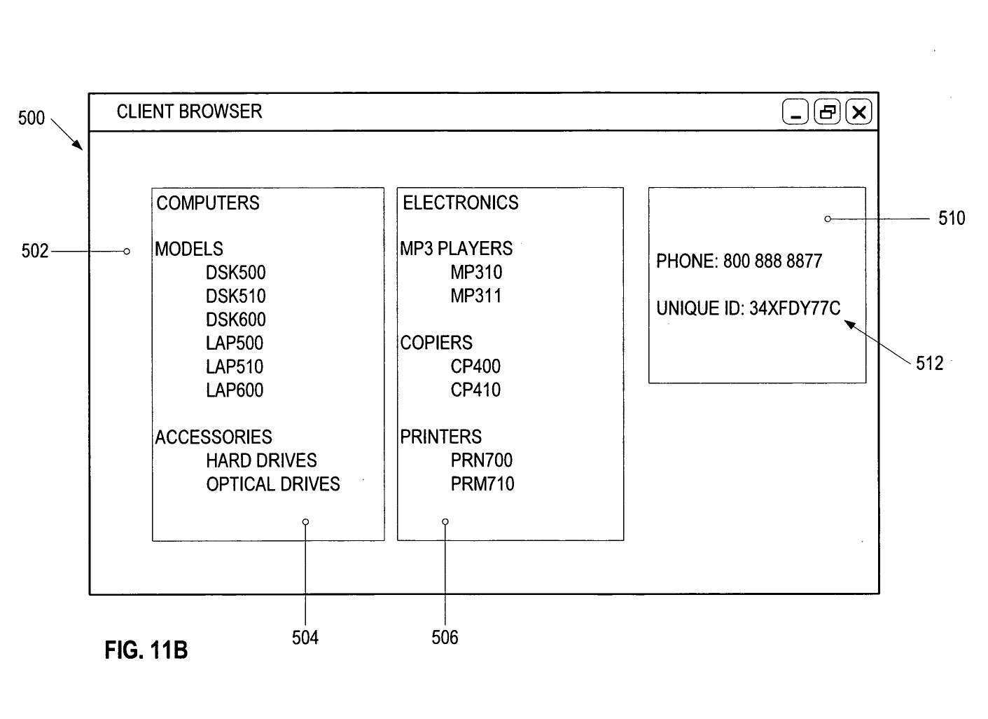

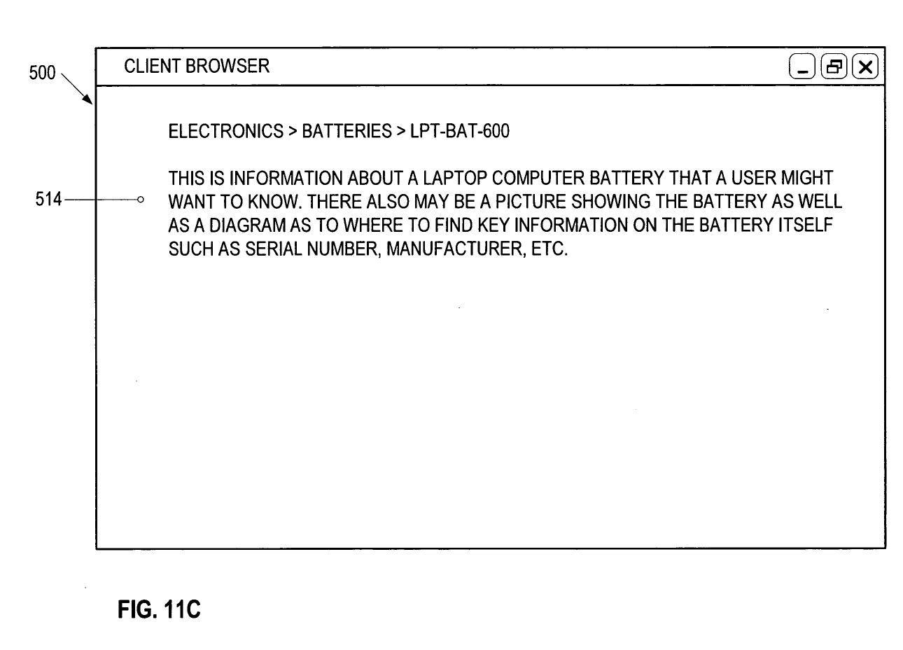

Turning now to FIGS. 11a, 11b, 11c, 12, and 13, simulated screens are shown to illustrate a user interface that allows a client browser and/or customer service agent to interact with the server directed browsing application 200. These screens can be displayed to users on output device(s) 711 (of FIG. 14). Furthermore, these screens can receive input from users from input device(s) 712 (of FIG. 14).

FIG. 11a shows a web browser 500 for one implementation that contains web page 502. Web page 502 is comprised of content section 504, content section 506, and call customer service button 508. Suppose for example that a user is attempting to find a specific piece of information in one of the two content sections, but is unable to find it. The user may click on call customer service button 508 which will alter web page 502 as shown in FIG. 11b. In FIG. 11b, content section 510 is shown to the user which may contain content (such as a phone number) and unique identifier 512. Continuing the example, the user then communicates with the customer service representative (over the computer, telephone, and/or one of other means of communication) to give the customer service representative the value of the unique communication identifier 512 and/or to describe their problem or issue. In this example, the information desired is the locating of a specific piece of information. The customer service representative may then send commands using a command service agent (discussed in detail later) to the user's web browser 500. In FIG. 11c, web browser 500 has navigated to a new page 514 based on a command initiated by the customer service representative. This new page 514 contains the information the user was originally seeking.

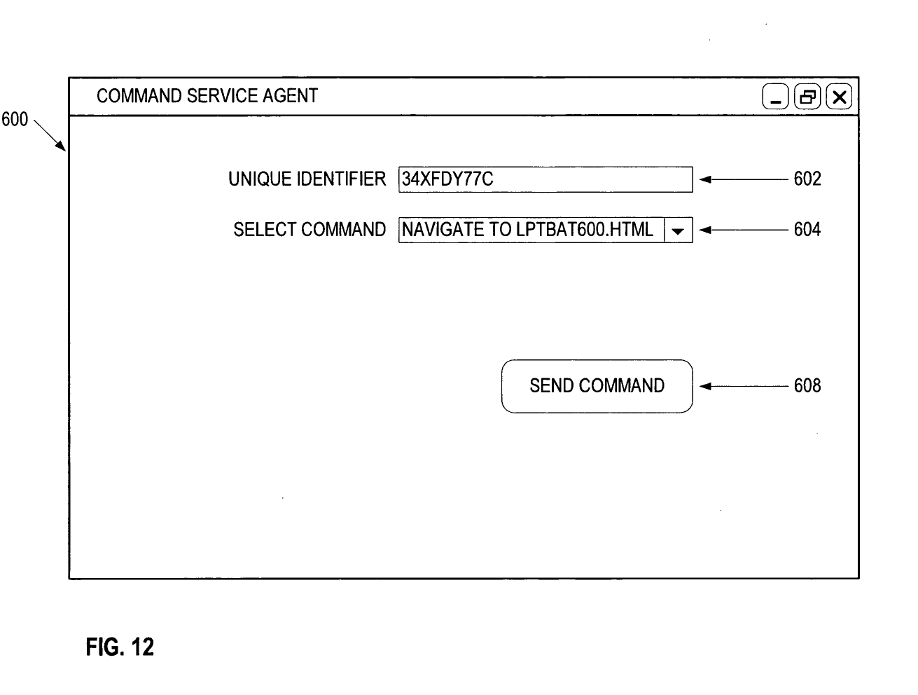

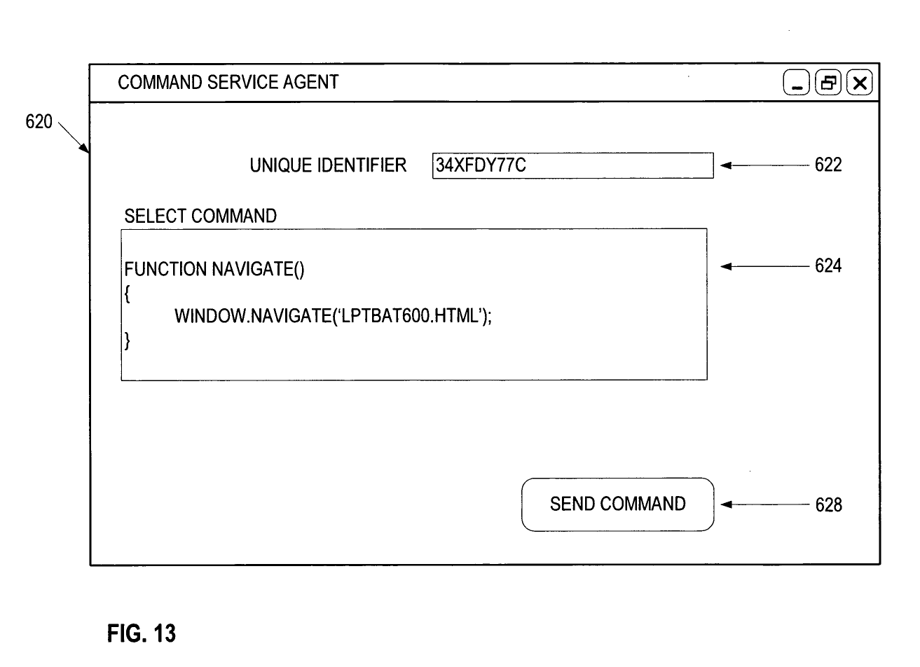

Turning now to FIGS. 12 and 13, simulated screens are shown to illustrate a user interface that allows a user to interact with the server directed browsing application for providing customer service. FIG. 12, in one implementation, shows simulated screen 600 of a command service agent that is used by a customer service agent to select a proper response from a list of available responses. Simulated screen 600 contains text box 602 for the entry of the client application's unique identifier, dropdown list 604 which contains a list of all the available commands that can be sent. In one implementation, simulated screen 600 can alternatively or additionally include additional parameters which allow for the entry of arguments or parameters that the command selected in drop down list 604 may require. Simulated screen 600 also contains button 608 which sends the command selected in drop down list 604 to a command queue for retrieval by a client application that has a unique communication identifier matching the one of text box 602.

FIG. 13, in one implementation, shows simulated screen 620 of a command service agent that is to be used to allow a customer service agent to manually specify the commands to send to the client browser. Simulated screen 620 contains text box 622 for the display and/or entry of the client application's unique communication identifier and text box 624 allows for the creation of commands using a language such as JavaScript or VBScript. Simulated screen 620 also contains button 628 which sends the command created in textbox 624 to a command queue for retrieval and execution by client browser that has a unique communication identifier matching the one of text box 622.

As shown in FIG. 14, an exemplary computer system to use for implementing one or more parts of the system includes a computing device, such as computing device 700. In its most basic configuration, computing device 700 typically includes at least one processing unit 702 and memory 704. Depending on the exact configuration and type of computing device, memory 704 may be volatile (such as RAM), non-volatile (such as ROM, flash memory, etc.) or some combination of the two. This most basic configuration is illustrated in FIG. 14 by dashed line 706.

Additionally, device 700 may also have additional features/functionality. For example, device 700 may also include additional storage (removable and/or non-removable) including, but not limited to, magnetic or optical disks or tape. Such additional storage is illustrated in FIG. 14 by removable storage 708 and non-removable storage 710. Computer storage media includes volatile and nonvolatile, removable and non-removable media implemented in any method or technology for storage of information such as computer readable instructions, data structures, program modules or other data. Memory 704, removable storage 708 and non-removable storage 710 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 700. Any such computer storage media may be part of device 700.

Computing device 700 includes one or more communication connections 714 that allow computing device 700 to communicate with other computers/applications 715. Device 700 may also have input device(s) 712 such as keyboard, mouse, pen, voice input device, touch input device, etc. Output device(s) 711 such as a display, speakers, printer, etc. may also be included. These devices are well known in the art and need not be discussed at length here.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. All equivalents, changes, and modifications that come within the spirit of the implementations as described herein and/or by the following claims are desired to be protected.

For example, a person of ordinary skill in the computer software art will recognize that the client and/or server arrangements, user interface screen content, and/or data layouts as described in the examples discussed herein could be organized differently on one or more computers to include fewer or additional options or features than as portrayed in the examples.

What is claimed is:

1. A computer-readable medium having computer-executable instructions for causing a computer to perform steps comprising:
after determining that a user needs assistance with one or more particular issues, agree on a unique communication identifier with a client browser being operated by the user;
receive asynchronous requests from the client browser after the client browser loads a script library which causes the asynchronous requests to begin; and
submit one or more responses to a command queue so that the asynchronous requests from the client browser will pick up the one or more responses on a later communication, the one or more responses being one or more commands that the client browser can later execute.

2. The computer-readable medium of claim 1, wherein the script library is operable to allow the client browser to communicate asynchronously with a server for receiving one or more responses to address the one or more particular issues.

3. The computer-readable medium of claim 2, wherein the script library is further operable to allow the client browser to communicate asynchronously with the server for sending one or more communications to a feedback queue on the server.

4. The computer-readable medium of claim 1, wherein the unique communication identifier is generated by a server and sent to the client browser.

5. The computer-readable medium of claim 1, wherein the unique communication identifier is provided by the client browser.

6. The computer-readable medium of claim 1, wherein the unique communication identifier is used to send directed commands to the client browser.

7. The computer-readable medium of claim 1, wherein the script library is sent to the client browser before the script library is loaded.

8. The computer-readable medium of claim 1, wherein at least some of the one or more responses are operable to be received from a customer service representative before the one or more responses are submitted to the command queue.

9. The computer-readable medium of claim 1, wherein at least some of the one or more responses are operable to be determined programmatically before being submitted to the command queue.

10. A method for providing server directed browsing comprising the steps of:
receiving a notification that a requesting user has asked for assistance on a particular one or more issues;
receiving input from a responding user to select an appropriate response; and
submitting the appropriate response to a command queue in the form of one or more commands, the command queue being asynchronously contacted by a client browser being operated by the requesting user through a communication process that was established when the client browser initiated a first contact, and the command being in a format that the client browser can execute.

11. The method of claim 10, wherein the responding user is a customer service agent.

12. The method of claim 10, wherein at least some of the one or more commands are a script that the client browser can execute.

13. The method of claim 10, wherein the input is one option selected from a list of available responses.

14. The method of claim 13, wherein at least some of the one or more commands are associated with the one option that was selected by the responding user.

15. The method of claim 10, wherein the input is entered by the user in the form of one or more actual commands, the one or more actual commands being the one or more commands that are submitted to the command queue.

16. The method of claim 10, wherein the command queue is located on a server computer.

17. A computer-readable medium having computer-executable instructions for causing a computer to perform the steps recited in claim 10.

18. A method for seeking directed browser assistance from a server comprising the steps of:
requesting assistance with one or more particular issues;
agreeing on a unique communication identifier with a web server;
loading a script library, which causes an asynchronous communication process with the web server to begin;
sending asynchronous requests to the web server to see if any responses are present for the one or more particular issues;
during a particular one of the asynchronous requests, receiving one or more responses in the form of one or more commands; and
executing the one or more commands in the client browser.

19. The method of claim 18, wherein the asynchronous communication process with the web server allows the client browser to receive commands from the web server in a controlled environment with a defined security policy so that the web server can provide responses to the one or more particular issues.

20. A computer-readable medium having computer-executable instructions for causing a computer to perform the steps recited in claim 18.
